(19) United States
(12) Patent Application Publication
(10) Pub. No.: US 2025/0202258 A1
(43) Pub. Date: Jun. 19, 2025

(54) HYBRID BATTERY SYSTEMS AND METHODS FOR APPLICATIONS

(71) Applicant: Haylon Technologies LLC, Iselin, NJ (US)

(72) Inventors: Namin Shah, Iselin, NJ (US); Dante Vaisbort, Iselin, NJ (US); Raj Lulla, Iselin, NJ (US)

(21) Appl. No.: 18/845,315

(22) PCT Filed: Mar. 9, 2023
(86) PCT No.: PCT/US2023/064079

§ 371 Date: Sep. 9, 2024

Related U.S. Application Data
(60) Provisional application No. 63/318,346, filed on Mar. 9, 2022.

(51) Int. Cl. H02J 7/00; B60L 50/40; B60L 50/60; H02J 7/34

(52) U.S. Cl. CPC H02J 7/0068; B60L 50/40; B60L 50/60; H02J 7/0048; H02J 7/0063; H02J 7/345; H02J 2207/20

(57) ABSTRACT

A hybrid battery system comprises a high-power energy element; a high-capacity energy element; a switching element; a sensor configured to measure current draw; and a microcontroller. Current draw by an electrical load from the hybrid battery system is monitored, and indicators of a state-of-charge (SOC_{HP}) of the high-power energy element and a state-of-charge (SOC_{HC}) of the high-capacity energy element are measured or calculated. Supply of current to the electrical load from either the high-power energy element or the high-capacity energy element is adjusted. A smart battery management system controls or adjusts the discharge curve of the high-capacity energy.

### CROSS-REFERENCE TO RELATED APPLICATIONS

This application claims priority to and benefit of U.S. Provisional Patent Application No. 63/318,346, filed on Mar. 9, 2022, the contents of which are incorporated herein by reference in their entirety.

### FIELD OF THE INVENTION

The present invention relates to hybrid battery system and methods to improve achievable energy density, power density, cyclic stability, and overall performance of battery packs using complementary battery cell varieties and intelligent software.

### BACKGROUND OF THE INVENTION

Batteries are used as a power source for many kinds of devices, including aerial devices and electric vehicles. The choice of battery to be used in a device depends on numerous considerations, such as weight, size, capacity, charge/discharge current, charge time, safety, heat generation, reliability, life span, and others.

Rechargeable batteries have limitations due to properties specific to their chemistry and production methods. The most common rechargeable batteries have been traditional lithium-ion batteries. Other battery chemistries such as lithium-titanate or lithium iron phosphate can charge and discharge quicker than the dominant lithium-ion batteries, but generally have lower energy densities. Battery chemistries such as lithium-sulfur, lithium-metal, solid-state lithium-ion, and silicon-anode lithium-ion exhibit better energy density than standard lithium-ion batteries, yet struggle with problems such as power density, cyclic stability, and calendar life. These variations happen for many reasons, some inherent to the power cells or other energy elements employing the various battery chemistries. Existing solutions fail to bridge the gap between complementary varieties of cells.

Simply stacking a high-capacity battery cell and a complementary power cell or cyclically stable cell in parallel (assuming ORing diodes are used, and cell voltages are the same) would not ensure that the high-capacity cells follow a specific discharge curve. The first reason is that the high-capacity cells and the other cells do not have internal resistances that are at all proportional to their relative cyclic stability and their maximum discharge rate. Put simply, all these batteries have similar internal resistances, unlike capacitors which have minimal internal resistance relative to batteries. This is why output capacitors are effective in such a simple arrangement as buffers to deal with large current spikes. Capacitors also have an incredibly long use-of-life. However, capacitors do not make good energy storage elements because of their extremely limited energy density and size, which makes them impractical in most applications smaller than a stationary battery energy storage system. Rechargeable batteries which contain energy densities several orders of magnitude above most capacitors are viable options. However, batteries typically become unusable over shorter time periods than capacitors, and current spikes that capacitors are designed to handle cause a battery's discharge curve to have a chaotic shape and can rapidly accelerate the battery's degradation.

In a moving vehicle, during a period of acceleration where the cell's current draws spikes, although the high-power cell would absorb part of the spikes, the high-capacity cell would still experience a larger current draw during this period. Although this impact is minimal in the scope of one cycle, the constant fluctuation in the current draw would detrimentally impact the total lifespan of the batteries. For two rechargeable batteries with different chemistries to work in conjunction, there remains a need for a more sophisticated solution.

There is a need for battery systems and methods that combine extended battery capacity, higher power output, and decreased degradation.

### SUMMARY OF THE INVENTION

The present disclosure provides a variety of improvements over existing battery systems and methods. As one aspect of the present technology, a smart hybrid battery system comprises a high-power energy element; a high-capacity energy element; a connector for supplying electrical current from the hybrid battery system to an electrical load; a switching element between the connector and the high power energy element and/or the high-capacity energy element, wherein the switching element is configured to selectively establish or block electrical connection between the connector and one or both of the high power energy element and the high-capacity energy element; a sensor configured to measure current draw by the electrical load from the high power energy element and/or the high-capacity energy element; and a microcontroller configured to receive signals representing:
(i) a current draw measurement from the magnetic field sensor,
(ii) a state-of-charge of the high-capacity energy element (SOC_{HC}),
(iii) a state-of-charge of the high-power energy element (SOC_{HP}), and
wherein the microcontroller is further configured to operate the switching element to selectively connect the high-power energy element and/or the high-capacity energy element to the electrical load based on the detected SOC_{HP}, the detected SOC_{HC}, and the current draw measurement. In some embodiments, the hybrid battery system is for a moving vehicle, and the electrical load is from moving or operating the device. For such systems, the microcontrollers can also be configured to detect or receive a signal indicative of speed and/or acceleration of the moving vehicle. In some embodiments, the hybrid battery system is a portable electronic device, and the electrical load is from operating the device or changing device settings. For such systems, the microcontrollers can also be configured to detect or receive a signal indicative of a particular use-case or device setting being selected.

As another aspect of the present technology, methods are provided for operating a hybrid battery system comprising a high-power energy element and a high-capacity energy element. The method comprising the steps of:
a) monitoring a current draw by an electrical load from the hybrid battery system;
b) measuring a state-of-charge (SOC_{HP}) of the high-power energy element;
c) measuring a state-of-charge (SOC_{HC}) of the high-capacity energy element;
d) upon detecting a spike in the monitored current draw, comparing the measured SOC_{HP} with a SOC_{HP} limit, and comparing the measured SOC_{HC} with a SOC_{HC} limit, and based on the detected spike and the comparisons, adjusting supply of current to the electrical load from either the high-power energy element or the high-capacity energy element.

In some embodiments, the method further comprises analyzing raw data from usage patterns of electronic devices to determine the limits and thresholds for switching. In some embodiments, the current draw threshold and the SOC_{HC} threshold are floating values which can change between charge cycles or throughout a charge cycle. The method can further comprise charging the high-power energy element from the high-capacity energy element at a variably controllable rate to enable the high-capacity energy element to have a desired discharge curve through each discharge cycle. In some embodiments, the high-power energy element is recharged from the high-capacity energy element during operation of the device. In some embodiments, the high-power energy element is continuously recharged from the high-capacity energy element.

In some embodiments, the method comprises charging the high-power energy element from the high-capacity energy element to shape the discharge curve of the high-capacity element. The rate at which the high-capacity energy element discharges is controllable by a control algorithm. The present disclosure provides a solution where the high-power cell (which can survive for several times as many charge cycles) can be intelligently used as a power buffer to control the discharge curve of the high-capacity cell.

As another aspect, the present technology includes new physical battery combinations, such as a hybrid battery comprising a high-capacity battery chemistry and high power battery chemistry. Examples of such battery chemistries include but are not limited to;

| | High power energy |
|---|---|
| High capacity energy elements | elements cells |
| Lithium Nickel Manganese | Lithium Iron Phosphate |
| Cobalt Oxide (NMC) | (LiFePO4) - LFP |
| Lithium Nickel Cobalt | Lithium cobalt oxide |
| Aluminum Oxide | (LCO) |
| (LiNiCoAlO2)- NCA | |
| Silicon-Anode Lithium-Ion | Lithium Polymer |
| Solid-State Lithium-Ion | Lithium Titanate |
| | (Li2TiO3) - LTO |
| Lithium-Sulfur | Sodium-Ion |
| Lithium Metal | Lithium Manganese |
| | Oxide (LiMn2O4) - LMO |
| Lithium Nickel Manganese | Lithium Manganese |
| Cobalt Oxide | |
| (LiNiMnCoO2) | |
| Lithium-Air (Li-air) | |
| Metal-Air | |

In some embodiments, a hybrid battery system comprises a high capacity energy element selected from the group consisting of NMC, NCA, lithium-sulfur, silicon-anode lithium ion, solid-state lithium ion, lithium metal, lithium nickel manganese cobalt oxide, lithium-air, metal-air cells and combinations thereof, and a high-power energy element selected from the group consisting of LFP, LCO, LTO, LMO, a lithium polymer, sodium-ion, lithium manganese, supercapacitor, fuel cell, nuclear battery, flywheel, or another alternative storage device, and combinations thereof.

As another aspect of the present technology, this disclosure provides methods of intelligently hybridizing batteries and various devices for hybrid battery systems. These methods can employ a device that switches between a high-capacity battery chemistry and a high-power battery chemistry for use in a hybrid chemistry battery. The present disclosure also provides a hybrid battery system comprising a larger high-capacity energy element, paired with a smaller high-power energy element, which can recharge from the high-capacity energy element during operation at variable speeds, depending on power draw. In some embodiments, the ratio of high-capacity to high power elements is 60%-40%, whereas in other embodiments, 95%-5% ratios are more advantageous. The present disclosure also provides a device that switches between different energy elements having different battery chemistries that utilizes a buffer circuit comprising power converters to maintain an output voltage that follows a normal, ideal or reference battery's discharge curve. The present disclosure also provides a device that has two or more switching elements arranged to pulse-charge, step-charge, algorithmically charge based on current demands and power spike predictions or apply a novel methodology to charge the high-power energy element while simultaneously supplying energy to the load. The present disclosure also provides a device that has a flying capacitor to pulse charge the high-power energy element while simultaneously supplying energy to the load. The present disclosure also provides a hybrid battery that utilizes a low-power microcontroller that runs the front end of a control algorithm, which evaluates current draw, speed, acceleration, location of the vehicle, and/or state of charge to determine when to switch from energy elements.

In some embodiments of the present methods and systems, the system switches to the high-power energy element when the load current draw is higher than a current draw threshold and/or the SOC_{HC} is lower than a SOC_{HC} threshold. The current draw threshold and the SOC_{HC} threshold can be floating values that change throughout each charge cycle. The current draw threshold and the SOC_{HC} threshold are recalculated by the controller based on data obtained from operation of the device.

In some embodiments, data from operation of the device is transmitted to a cloud database. Instructions from the cloud database can be transmitted back to the controller of the hybrid battery system, such as instructions comprising one or more adjustments to the current draw threshold and/or the SOC_{HC} threshold.

As another aspect, a method of determining a current draw threshold and/or a SOC_{HC} threshold comprises analyzing the usage patterns of specific electronic devices and their power requirements. The thresholds can be floating values that change throughout each charge cycle and/or can be recalculated by the controller based on data obtained from operation of the device

These and other features and advantages of the present systems and methods will be apparent from the following detailed description, in conjunction with the appended claims.

### BRIEF DESCRIPTION OF THE DRAWINGS

FIG. 1 is a circuit schematic of an embodiment of a dynamic hybrid battery system comprising a high-power energy element and a high-capacity energy element.

FIG. 2 is a block diagram of an embodiment of a hybrid battery system.

FIG. 3 is an illustration of the use of an embodiment of a hybrid battery system in a rotary drone.

FIGS. 4, 5A, 5B, 6A, and 6B are flowcharts illustrating control algorithms for operating a hybrid battery system.

FIG. 7 is a circuit schematic of an embodiment of a dynamic hybrid battery system comprising a low-side switching element.

FIG. 8 is a block diagram of another embodiment of a hybrid battery system.

FIG. 9 shows an equation for estimating the likelihood of a power spike occurring and using that likelihood to decide which energy element to use.

FIG. 10 shows a control algorithm for use cases where connectivity of the system to a cloud database is sparse or nonexistent.

The present teachings are best understood from the following detailed description when read with the accompanying drawing figures. The features are not necessarily drawn to scale.

### DETAILED DESCRIPTION

It is to be understood that the terminology used herein is for purposes of describing particular embodiments only and is not intended to be limiting. The defined terms are in addition to the technical and scientific meanings of the defined terms as commonly understood and accepted in the technical field of the present teachings.

Due to the recent advances in low-power computing and battery technology, there is room for improvement in today's battery technology. The present disclosure improves upon the current method of employing rechargeable batteries for various uses, such as with drones and other uses requiring a high gravimetric energy density. Existing battery systems face difficulty addressing both power and energy density requirements, especially in drones and other electric aircraft. Cell improvements, particularly those common in lithium-based rechargeable batteries, generally only address power density or energy density. The more energy dense chemistries are inherently limited in their power density. Other energy storage elements, such as supercapacitors or lithium titanate batteries, have extremely high power densities. However, these elements bring their own limitations as far as energy density.

The present disclosure provides a novel type of hybrid battery system that can intelligently switch between two (or more) separate energy elements, leveraging the strengths of each. Traditional energy storage systems consist of mono-chemistry lithium-ion battery cells that always remain connected to the electrical load. The present disclosure demonstrates a system that deviates from these traditional systems by seamlessly switching between multiple energy elements in response to changes in but not limited to electrical load conditions. Previous efforts to unlock the benefits of multiple battery chemistries have been limited to static switches between entirely separate systems of batteries. Combining chemistries in the same system requires the ability to dynamically switch between chemistries in a manner that accounts for changes in all energy storage elements over time. The present disclosure pioneers a method of switching between multiple battery chemistries dynamically, and in concert with a backend algorithm that fine-tunes the selection process over time. In some embodiments, the two (or more) energy elements differ in their discharge rates and/or power density and/or other characteristics. In some embodiments, the present invention enables the greater energy density of one element to provide additional capacity, while switching to a more power dense element to provide sufficient power for the device and spare the energy dense element from premature degradation during high power draw. For example, a hybrid battery system may comprise a supercapacitor bank and a lithium-ion battery pack, switching to power a simple quadrotor. The lithium-ion batteries could supply the device with power until it exceeded a pre-set value. Were the device's power draw to exceed that value, the supercapacitor would be drawn upon to supply any additional power. The same approach could be employed with two different batteries. A silicon-anode energy cell would supply baseline power and a lithium iron phosphate battery could provide supplemental additional power during spikes.

The present disclosure provides a solution to one of the reasons or causes of cyclic instability with high-energy cells, meaning that they do not retain their capacity after many charge/discharge cycles. By controlling the discharge curve that the battery experiences during each cycle and the depth of discharge, the present methods and systems increase cyclic stability. The discharge curve can be controlled and even optimized by a battery management system that can selectively shift power draw to or from another energy element in the hybrid battery system. In the present embodiment, this control comes from modulating the switching frequency of the switch connected to each element.

The present hybrid battery systems include a high-power energy element and a high-capacity energy element. A high-power energy element is one that has a higher power density than traditional rechargeable cells, typically a battery chemistry or energy storage system specifically designed for a greater discharge rate. In some embodiments, the high-power energy element comprises LFP, LCO, LTO, LMO, a lithium polymer, sodium-ion, or lithium manganese; it should be noted, however, that in some embodiments where these store more energy than another energy storage element, these energy elements may be high-capacity energy elements. In some embodiments, the high-power energy element is a supercapacitor, hydrogen fuel cell, nuclear battery, flywheel. A supercapacitor (SC) is a high-capacity energy element with a capacitance of 1 farad or higher, alternatively at least 5 farads. Exemplary supercapacitors include Kyocera AVX and are commercially available from Digikey electronics.

A high-capacity energy element is one that stores more energy than the high-power energy element, but cannot achieve the same discharge rates. In some embodiments, the high-capacity energy element is one that has a lower voltage than a high-power energy element of the hybrid battery system. In some embodiments and depending on the choice of high-power energy element, the high-capacity energy element comprises an lithium nickel metal cobalt oxide, lithium-sulfur, silicon-anode lithium ion, solid-state lithium ion, lithium metal, lithium-air, or metal-air, (LiNi0.8Co0.15Al0.05O2) (NCA) or lithium NiₓMn_{y}Co_{z}O₂ (NMC) element. Lithium-sulfur (Li—S) battery cells have an anode comprising lithium and a cathode comprising sulfur which is reduced to lithium sulfide (Li₂S) during discharge. Li—S batteries have high specific energy and high energy density, with some having specific energies of 450 Wh/kg or higher. Lithium NMC cells have a positive electrode comprising lithium NMC and a negative electrode comprising graphite or other material. Lithium NMC batteries have greater specific energy and specific power density than most lithium-ion cell types (c.a. 260 wh/kg) and are frequently used in electric vehicles. It should be noted, however, that in some embodiments these energy elements may be high-power energy elements relative to another energy element of the hybrid battery system.

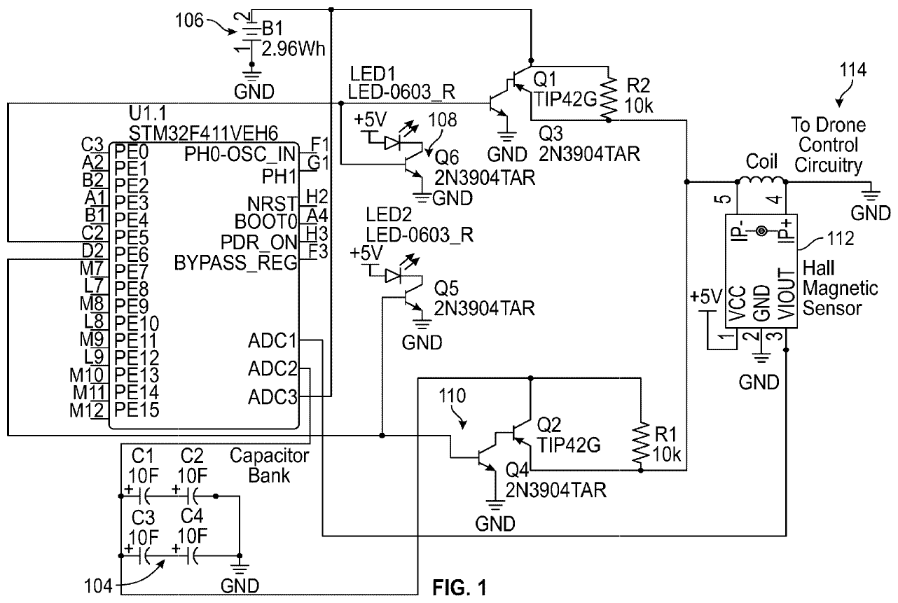

In the embodiment illustrated in FIG. 1, the high-power energy element is a 5.4-volt 10 Farad supercapacitor bank 104 and the high-capacity energy element is a 3.7 volt 2.96 Wh lithium-ion battery 106. This hybrid battery system comprises a switching element between the connector and the high-power energy element 106 and/or the high-capacity energy element 104, wherein the switching element is configured to selectively establish or block electrical connection between the connector and one of or both the high-power energy element and the high-capacity energy element. In the hybrid battery system of FIG. 1, the switching element utilizes an adapted version of PNP high side switching with a first switch 108 and a second switch 110. The first switch 108 is between a connector and the high-power energy element 106, and the second switch 110 is between a connector and the high-capacity energy element 104. The system reduces or minimizes the on-state resistance of the switches so that during either energy state the current wasted to the MOSFETS remains at an ultimate minimum. This present disclosure is only one embodiment of the switches that can be used. The present invention requires low resistance, electrically driven switches which could consist of electromechanical relays, Bipolar Junction Transistors, diodes of various kinds including but not limited to Schottky diodes, zener diodes, photodiodes, and optoisolators. The present disclosure utilizes an optoisolator in conjunction with low resistance low on-state voltage MOSFETS. The present embodiment carefully considers the turn on time as a quick response to drive signals is crucial for dynamic switching. The drive signals are provided by GPIO pins of the STM32 Nucleo which was the programming environment utilized in this embodiment.

The hybrid battery system of FIG. 1 also comprises a sensor 112 configured to measure current draw by the electrical load 114 from the high-power energy element 106 and/or the high-capacity energy element 104. The hybrid battery system 100 also comprises a microcontroller 102 configured to receive signals representing:
(i) a current draw measurement from the sensor,
(ii) a state-of-charge of the high-capacity energy element (SOC_{HC}),
(iii) a state-of-charge of the high-power energy element (SOC_{HP}),
(iv) speed and/or acceleration of the moving vehicle, and
   wherein the microcontroller is further configured to operate the switching element to selectively connect the high-power energy element and/or the high-capacity energy element to the electrical load based on the detected SOC_{HP}, the detected SOC_{HC}, and the current draw measurement.

In some embodiments, the present systems and methods further comprise a power converter or buffer circuit that is connected to bring charge from the high-capacity energy element to the high-power energy element. The power converter or buffer circuit enables a hybrid battery system to have a high-capacity element at a lower voltage than the high-power energy element, but can be used to charge the high-power energy element. The controller can by changing a duty cycle, quickly adjust the rate of power transfer from one element to the other. This is true due to the nature of switch mode power converters. Examples include but are not limited to boost, buck, boost-buck, flyback converters etc. By modulating their duty cycle, the controller can directly modulate output voltage sufficiently to allow for charging regardless of a specific chemistry's state-of-charge.

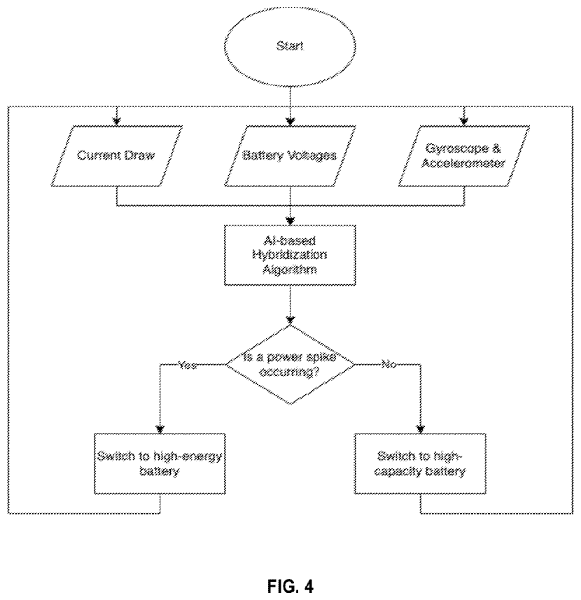

As another aspect of the present technology, the methods and systems are configured to store code for and perform a control algorithm, detailed in FIG. 4, for operating a hybrid battery as described herein. The control algorithm can be employed to manage the discharge curve of the high-capacity energy element. The control algorithm is input with data indicative of: (i) a current draw by an electrical load from the hybrid battery system, (ii) a state-of-charge of the high-capacity energy element (SOC_{HC}), and (iii) a state-of-charge of the high-power energy element (SOC_{HP}). For an electrical load of a moving vehicle, the control algorithm can also be input with data indicative of (iv) speed and/or acceleration of the moving vehicle. Other possible inputs include time, more specifically duration, speed, acceleration, individual cell temperature, internal resistance, GPS location, environmental conditions such as humidity, temperature, and available sunlight. The control algorithm can evaluate the timing for each of the energy elements to supply power to the electrical load whilst simultaneously determining how quickly the high-power energy element recharges. In some embodiments, the control algorithm selects or adjusts the current supplied by one or both of the energy elements to the electrical load so that the discharge curve of the high-capacity energy element substantially follows a constant discharge over time, as opposed to a constantly changing discharge curve that normally exists, particularly with moving vehicles. For an unmanned aerial vehicle such as an RC airplane, the battery management system also includes a gyroscope and an accelerometer to provide data indicative of the speed and/or acceleration of the unmanned aerial vehicle. The control algorithm can use such data as inputs to predict the upcoming power draw and prepare, instruct, or control the energy elements to supply the electrical load.

The present systems and methods are especially suited when employed for moving vehicles, such as aerial devices and electric vehicles, as such devices have highly variable, particularly chaotic power demands that often necessitate the use of power dense battery cells or results in less-than-optimal results from energy cells such as NMC due to moderate or high discharge rates. Exemplary moving vehicles include Unmanned Aerial Vehicles (or drones), eVTOLs, remote-controlled airplanes, electric bikes, electric motorcycles, wheelchairs, golf carts, snowmobiles, scooters, all-terrain vehicles (ATVs), and boats. Drones include rotary drones and fixed-wing drones. The present systems and methods can be employed with nanodrones (weighing up to 250 g), Micro air vehicles (MAV) (250 g-2 kg), Miniature or small UAVs (SUAVs) (2-25 kg), medium air vehicles (25-150 kg), and large drones (over 150 kg). Other examples include electric scooters, boats, motorcycles, golf carts and other small to midsized drone systems.

The hybrid battery system comprises a smart battery management system. A low-power microcontroller manages high-side switching circuits which connect each energy element buffer to a load, such as a moving vehicle. The controller can also control the duty cycle of a power converter that brings charge from the high-capacity energy element to the high-power energy element. The controller is configured to precisely control the timing and the speed at which the high-capacity energy element charges the high-power energy element and can update this pattern based on observed results. The controller and/or an algorithm employed by the microcontroller is configured to manage the discharge curve of the high-capacity cell during a real-life use case in an actual electronic device. To do so, the battery management system measures current draw, and the state of charge of each energy element, periodically or continuously, and evaluates the exact timings for each energy element to supply power to the load whilst simultaneously determining how quickly the high-power energy element recharges. In some embodiments, the microcontroller and/or an algorithm employed by the microcontroller is configured to switch between different energy elements to maintain an output voltage that follows a normal, ideal or reference battery's discharge curve, such as by providing a discharge curve that has little or no deviation from the normal, ideal or reference battery's discharge curve.

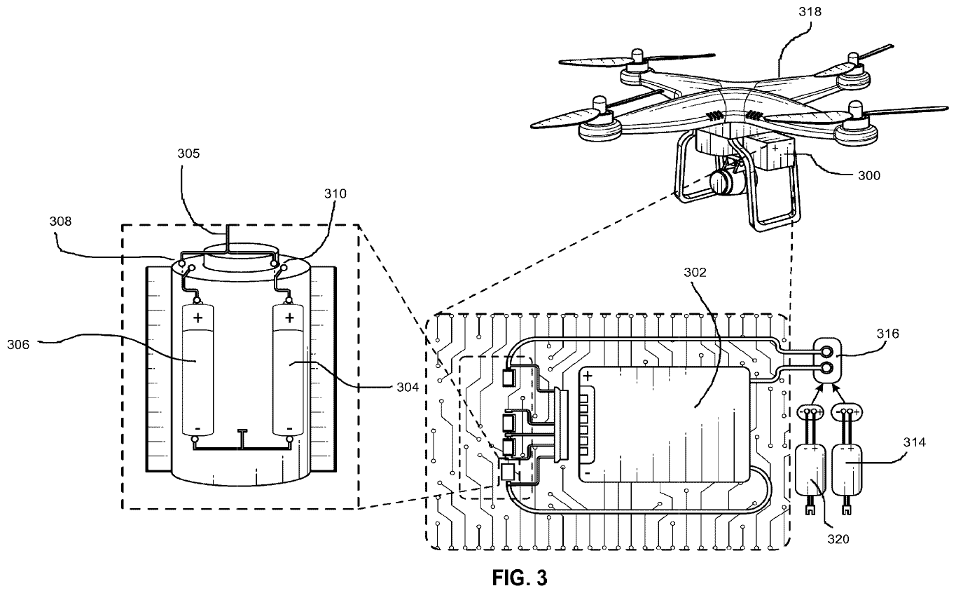

FIG. 3 is an illustration of the use of an embodiment of a hybrid battery system in a rotary drone 318. In this embodiment, the power demand of the rotary drone 318 will be the electrical load 314, though it is contemplated that this is representative of other vehicles or devices that comprise the electrical load 314. The hybrid battery system 300 comprises a high power energy element 306 and a high capacity energy element 304, such as those described herein. A connector 316 supplies electrical current from the hybrid battery system to an electrical load based on operation of the rotary drone 318. A switching element 305 is configured to selectively establish, block, limit or increase electrical connection between the connector 316 and one or both of the high power energy element 306 and the high capacity energy element 304. As illustrated in FIG. 3, the switching element 305 comprises a first switch 308 between the connector 316 and the high-power energy element 306 and a second switch 310 between the connector 316 and the high-capacity energy element 304.

Controller 302 is configured to receive signals indicative of (i) a current draw measurement from the sensor, (ii) a state-of-charge of the high-capacity energy element (SOC_{HC}); (iii) a state-of-charge of the high-power energy element (SOC_{HP}); and optionally other parameters. The controller 302 operates the switching element 305 to selectively connect the high-power energy element 305 and/or the high-capacity energy element 304 to the electrical load 314 based on the detected SOC_{HP}, the detected SOC_{HC}, the current draw measurement, and optionally other inputs such as acceleration of the rotary drone 318. FIG. 3 also shows a charging element 320 to which the hybrid battery system 300 can be connected for recharging.

In some embodiments, the measurements of current draw and state of charge of each energy element are recorded in the microcontroller and/or they may report to a remote data storage device periodically or constantly via Bluetooth serial or Wi-Fi or any other means of wired or wireless communication. In some embodiments, the control algorithm is adjusted based on the reported data, including but not limited to the use of machine learning program(s) to make the adjustment. In some embodiments, this machine learning is used to generate an algorithm which can be used to predict or identify upcoming or potential undesirable conditions, such as power usage, temperature fluctuations, and dangerous operating conditions, among other important metrics. The machine learning program can also provide instructions or guidance to the controller for operation of the hybrid battery system. In some embodiments, a machine learning program is configured to change or replace one or more thresholds or formulas employed by the controller for operation of the hybrid battery system.

The data recorded from operation of the hybrid battery system can be utilized to create a “true” discharge curve of each cell energy element during each cycle. With that knowledge, the control algorithm can be trained to better emulate a desired or ideal discharge curve. In some embodiments, the ideal discharge is determined based on a selected number of charge cycles that a battery pack comprising the energy elements should last and maximum discharge rates for the energy element can be set based on anticipated cycle lives when the cells are discharged at that level. In some embodiments, the number of charge cycles is selected in view of a stated product life for the energy elements of the hybrid battery system (e.g. when a product has a five-year warranty). The ideal discharge curve can also be determined by the manufacturer's reference discharge curve. The control algorithm can be subject to training until the high-capacity energy element will very closely follow a constant discharge over time, as opposed to a constantly or rapidly changing discharge curve that normally exists. For instance, an aerial moving vehicle such as an RC plane requires large current spikes quite often, and, during regular use, is not pushed to its capacity limit with each and every cycle. The present system can extend the usable lifespan of high-energy rechargeable batteries, as it would detect these conditions and offload a greater percent of the electrical load to the high-power element to best ensure long-term battery health of the high-capacity element. In some embodiments, a smart BMS also contains a gyroscope, a sensor to record GPS coordinates and an accelerometer, particularly when used for an aerial vehicle. The gyroscope and accelerometer can detect speed and/or acceleration, and data on speed and/or acceleration can be used to help create the control algorithm.

The present systems and methods will be especially beneficial for high-energy battery chemistry such as lithium-sulfur, which currently struggles with cyclic stability. The beneficial nature can also be demonstrated with a hybrid battery system comprising Lithium Nickel Cobalt Aluminum Oxide cells (Li-NCA) as the high-energy element and Lithium Iron Phosphate (LFP) cells as the high-power energy element. Both are commercially available on Digikey and other common electronic vendors and exhibit complementary strengths and weaknesses. Even though off-the-shelf batteries can be used to demonstrate this technology, they are used to create a plane battery pack that matches the maximum discharge rate of a regular LFP battery system, while having a higher total energy density by virtue of the high-capacity Li-NCA battery.

### Switching Element

The present systems and methods can include one or more switching elements which connect the high-power energy element and the high-capacity energy element to a connector. The switching element can be a semiconductor switch, for example, a metal oxide semiconductor field effect transistor (MOSFET) or an insulated gate bipolar transistor (IGBT) or a Bipolar Junction transistor (BJT) or an electromechanical relay. In some embodiments, the switching element has an on-state resistance of 10 mΩ or less. In some embodiments, the switching element comprises a parallel circuit of at least two semiconductor switches, such as BUK7E8R3. The gates of the semiconductor switches 108, 110 may be controlled by signals generated by the controller 102. In some embodiments an opto-isolator circuit is used to drive the switches. In some embodiments, a gate driver IC such as VO3150A may be used to ensure a timely response to a signal.

### Controllers

The present hybrid battery systems and methods can employ a controller. In general, a controller is one or more electronic devices capable of performing a series of instructions resulting in data manipulation. A controller typically contains one or more CPUs (processor cores) along with memory and programmable input/output peripherals. In some embodiments, the controller is a microcontroller (also referred to as a microprocessor), which is a compact microcomputer designed to govern the operation of embedded electronic devices, and various other electronic and mechanical devices coupled thereto or installed thereon. Microcontrollers may include processors, microprocessors, and other electronic components, such as an STM32 series microcontroller from ST Microelectronic. Other examples of microcontrollers include a 32-bit RISC CPU, such as an STR9 series microcontroller from ST Microelectronics or a 16-bit RISC CPU such as a processor from the MSP430 family of microcontrollers, from Texas Instruments may also be suitable. Microcontrollers have reduced size and cost compared to designs that use separate microprocessors, memory, and input/output devices. Other types of controllers can include application-specific integrated circuits (ASICS), Field Programmable Gate Arrays (FPGA), computer processors (CPU) and individual microprocessors, as well as analog circuitry wired to respond in a predictable manner to different inputs.

The hybrid battery system 100 shown in FIG. 1 utilizes a STM32 development board 102 to drive switching between a supercapacitor bank 104 and a lithium-ion battery 106. This switching determines which energy element is supplying power to the electrical load, which in the case of this project was a mounted quadrotor drone. The main conditions that the STM32 needed to detect were state of charge (SOC), and spikes in current draw. Upon detecting these conditions, the electrical load switching occurs accordingly. In some embodiments, this switching can be done with the ultimate goal of preserving overall battery health This can result in benefits such as longer battery life and more charge cycles as the supercapacitor can manage large current spikes that lead to battery degradation in most lithium-based batteries.

The controller can be configured to precisely control the timing and the speed at which the high-capacity energy element charges the high-power energy element. This can be a desirable feature of the aforementioned controller. The controller can be configured to store code for and perform a control algorithm for operating a hybrid battery as described herein.

The controller desirable is able to manipulate the charging speed of the high-power cell at rates between 0.1c and 2c depending on a signal from the controller. Exemplary rates include 0.1c, 0.2c, 0.5c, 1c and 2c. The controller in some embodiments consists of a mechanism to both store time-specific battery data and transmit stored data to a cloud database. The means of communication include but are not limited to, Wifi, Bluetooth, RF communication, near field communication, common inter-system wired communication protocols such as UART, USB, USART, common intra-system wired communication protocols such as I2C, SPI, CAN, and other CAN variations. Stored data is pushed to a cloud infrastructure using one of the aforementioned methods and processed in the backend. This is crucial to the present invention since it allows for live changes to discharge protocols. One of the biggest limitations to existing attempts at combining chemistries is the fact that batteries of different chemistries age differently. In a standard dual system setup, the switching routine does not respond to these changes causing imbalances in different battery chemistries which over time lead to failure. The present disclosure presents a solution to this problem unlocking many new energy storage elements for use, beyond just batteries, such as ultracapacitors, hydrogen fuel cells, and flywheels that don't degrade like batteries.

### Sensor

The present systems and methods include a sensor that is sufficiently sensitive to the current employed in a lightweight application, such as currents in a milliamp range (e.g., 0.1 to 1000 milliamps, or 1 to 600 milliamps). For example, a Hall magnetic sensor can be employed, such as VG481V1 available from Digikey electronics.

A Hall magnetic sensor was incorporated into the hybrid battery system of FIG. 1 in the following manner: A low resistance copper wire was wound around a toroid coil. A small slit in the toroid coils covers the hall magnetic sensor. As current flows through the twisted wire, its inherent magnetic field triggers the hall sensor to measure analog data which is used to determine the exact current draw. Far less power was wasted when the magnetic field of the current flow was measured. In some embodiments, an open looped current measuring circuit can be used. In others a closed loop current measurement may be utilized. The measuring technique employed can be anything from a shunt-based measurement to the magnetic based solution mentioned above, or both for added redundancy and accuracy. Post processing of the data from the sensor/sensors includes but is not limited to coulomb counting, a process in which current is integrated over time to measure state of charge.

The present systems and methods can also include various safety features, such as elements providing protection against overvoltage, undervoltage, and overly high temperatures. The hybrid batter system will shut off when unsafe conditions are detected.

In some embodiments, the present hybrid battery systems have a volumetric energy density of at least 400 Wh/L, or at least 500 Wh/L, or at least 600 Wh/L, and may be as high as 800 Wh/L or higher. In some embodiments, the present hybrid battery systems have a gravimetric energy density of at least 200 Wh/Kg, or at least 250 Wh/kg or 350 Wh/kg, and may be as high as 400 Wh/kg or higher. In some embodiments, the present systems and methods have or can have a volumetric energy density and a gravimetric energy density as described above (for example, a system may have a volumetric energy density of at least 600 Wh/L and a gravimetric energy density of at least 300 Wh/kg). In some embodiments, the present systems and methods have a total output in the voltages of exactly or approximately 3.7V, 5V, 7.2V, 7.3V, 7.4V, 9V, 10.8-11.1V, 12V, 14.4-14.8V, 21.6-22.2V, 25.2-25.9V, 28.8-29.6V, 32.4-33.3V, 36-37V, 39.6-40.7V, 43.2-44.4V and above.

### Applications

The present hybrid battery systems and methods can be used in any application which can benefit from one or more of the advantages described herein, including but not limited to Unmanned aerial vehicles; Electric watercraft; Electric Vertical Take-Off and Landing vehicles; Avionics; Electric passenger aircraft; Electric freight; Battery-powered personal mobility devices; Commercial equipment; Battery energy storage systems; Portable speakers; Novel audio transducers; Wireless headphones; Second-life battery packs; Cordless appliances; and Power tools.

Unmanned aerial vehicles such as lightweight drones are increasingly used to complete tasks such as transporting items, taking photographs, and offering entertainment. Drone batteries must deliver significant amounts of power for situations such as liftoff and acceleration, while using far less during normal flight operations. For this reason, most unmanned aerial vehicles rely on battery packs optimized for power density to the deficit of energy density, cycle-life and safety. The invention enables power-dense cells to be employed for a small window of time during a drone's usage pattern where they are necessary, and elsewhere drawing upon more energy dense cells.

Electric watercraft (boats, jet skis, etc.) must often discharge their batteries at very high rates despite having normal nominal voltages. The invention enables hybrid battery packs for electric watercraft that are applied in the same way and offer the same core benefit as for drones.

Electric Vertical Take-Off and Landing vehicle (EVTOL) are nascent technology generally aiming to transport 2-16 people over short distances, such as from downtown urban areas to airports. EVTOL crafts employ many battery packs due to safety reasons. All these packs use the same cell chemistry. EVTOL batteries are large and expensive, and discharged at higher c-rates than traditional electric vehicles are to keep aloft. The invention makes possible not only a combination of both energy and power dense cells within a single pack as in the drone use-case, but also a combination of packs that use energy dense cells used in tandem with separate packs that employ power dense cells, and a system that alternates between these different battery packs.

Avionics and onboard power supplies for conventional aircraft, helicopters, etc. often experience power spikes that prematurely degrade lithium-ion batteries even when power-dense cells are not necessary. The invention makes it possible to cap the power draw from an energy-dense cell and instead draw additional power from a cluster of power cells.

Electric passenger aircraft are viewed as infeasible due to limitations in battery energy density. The advent of new technologies is necessary to power electric flight. The invention can serve as an accelerant of novel energy dense chemistries by leveraging their strengths and alternating to another chemistry when they face the risk of premature degradation as device power draw increases.

Electric freight is like electric passenger air travel in that significant increases to achievable battery energy density are required for viability.

Battery-powered personal mobility devices such as unicycles, monowheels, scooters, skateboards, hoverboards, bikes, motorcycles, delivery robots, airplane tugs, golfcarts, wheelchairs, rickshaws, snowmobiles, etc. all benefit from the maximum achievable range but require variable amounts of power. Cycle life is more important for devices which are expensive or under warranty from their manufacturer.

Commercial equipment such as the above and more commercially focused equipment such as airplane tugs, construction vehicles and forklifts experience the same, in addition to the economic costs of battery replacement.

### Terminology

As used herein, the term “energy element” means a structure capable of storing and discharging electrical energy, including but not limited to batteries, hydrogen fuel cells,—

“State-of-Charge” (SOC) as used herein means an energy element's percentage of remaining charge, compared to the maximum level that a cell is charged (up to 100%) during a charge cycle. It should be understood that the maximum level for a given battery may decrease over its useful lifetime.

“Connector” as used herein refers to any structure or material capable of forming an electrical connection between parts of an electrical circuit, or between different electrical circuits, and/or capable of passing an electrical current from one component to another component. In some embodiments, electrical connectors have a male component or plug, or a female component, or socket. Connectors can be configured for manual connection (such as plugs and sockets for portable equipment), fastened connection (such as where a fastener attaches a connector to another component, or where a tool is needed for attachment or removal), or permanent connection such as a soldered electrical joint between two components. Examples of connectors include inline or cable connectors; chassis or panel connectors, PCB mount connectors, and splice or butt connectors.

“Current draw” as used herein refers to the amount of current an electrical load demands while it is operating. Current draw can be an instantaneous measurement or a mean over a given time period.

Energy density refers to the amount of energy that can be stored in a given system. Energy density is generally measured in energy per volume (Wh/L) (also referred to as volumetric energy density) though it can also be expressed in energy per mass (Wh/kg) (also called specific energy or gravimetric energy density). Power density refers to power output per unit volume (W/m³). Power density of an energy element is determined by the cell's reaction kinetics. Specific power of an energy element refers to power per mass (W/kg).

A “limit” as used herein is any value that signifies a condition or an event. A limit may be a predetermined value or a value calculated or derived from other values.

As used herein, the term “lightweight drone” refers to an unmanned (remotely piloted or controlled) aircraft having a weight less than 10 kg, and/or a power requirement less than 100 W. Lightweight drones typically have one or more rotary propellers with integrated or onboard power storage. A quadrotor drone is an example of a lightweight drone.

As used herein, the terms “substantial” or “substantially” mean to within acceptable limits or degree to one having ordinary skill in the art. For example, “substantially cancelled” means that one skilled in the art considers the cancellation to be acceptable.

As used herein, the terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same.

In the present disclosure, numeric ranges are inclusive of the numbers defining the range. It should be recognized that chemical structures and formula may be elongated or enlarged for illustrative purposes.

Unless defined otherwise, all technical and scientific terms used herein have the same meaning as commonly understood by those working in the fields to which this disclosure pertain.

Before the various embodiments are described, it is to be understood that the teachings of this disclosure are not limited to the particular embodiments described, and as such can, of course, vary. It is also to be understood that the terminology used herein is for the purpose of describing particular embodiments only and is not intended to be limiting since the scope of the present teachings will be limited only by the appended claims.

As disclosed herein, several value ranges are provided. It is understood that each intervening value, to the tenth of the unit of the lower limit, unless the context clearly dictates otherwise, between the upper and lower limits of that range is also specifically disclosed.

Unless defined otherwise, all technical and scientific terms used herein have the same meaning as commonly understood by one of ordinary skill in the art to which this disclosure belongs. Although any methods and materials similar or equivalent to those described herein may also be used in the practice or testing of the present teachings, some exemplary methods and materials are now described.

All patents and publications referred to herein are expressly incorporated by reference.

As used in the specification and appended claims, the terms “a,” “an,” and “the” include both singular and plural referents, unless the context clearly dictates otherwise. Thus, for example, “a sensor” includes one sensor and plural sensors.

In view of this disclosure it is noted that the present methods, compositions, and systems can be implemented in keeping with the present teachings. Further, the various components, materials, structures and parameters are included by way of illustration and example only and not in any limiting sense. In view of this disclosure, the present teachings can be implemented in other applications and components, materials, structures and equipment to implement these applications can be determined, while remaining within the scope of the appended claims.

### EXAMPLES

### Example 1

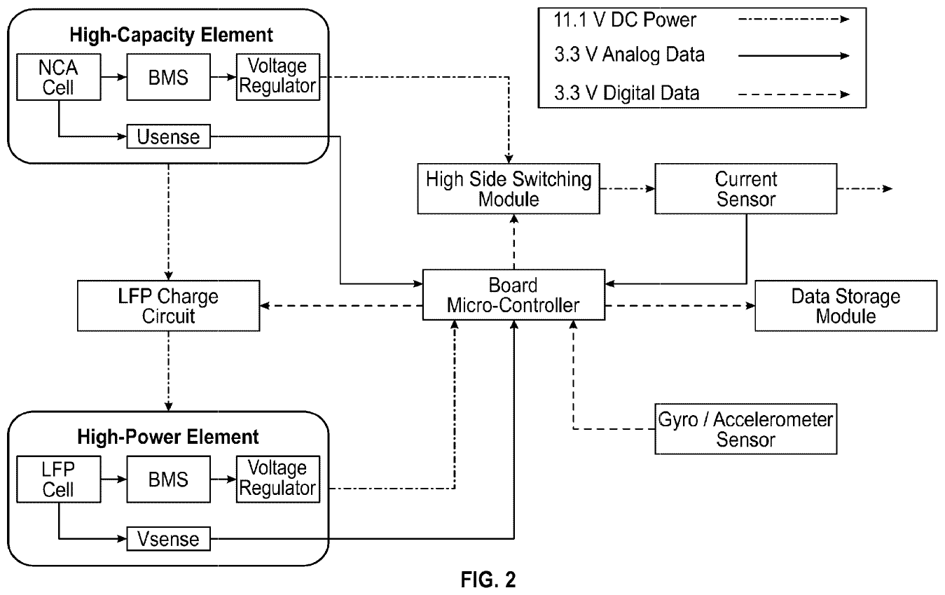

In this example, a Hall magnetic sensor is incorporated into a hybrid battery system to minimize power loss. The sensor includes a commercially available Hall magnetic sensor, a toroid coil and some copper wire. A very small slit was in the toroid coil to stick the hall sensor and the sensing wire around the coil as shown in FIG. 2. By measuring the magnetic field of the current draw from the hybrid battery system, much less power was wasted compared to a shunt resistor. However, in future embodiments, a shunt may be used for added redundancy.

### Example 2

FIG. 1 shows the high side switching and the control circuitry schematic. The hybrid battery system was tested in a drone, and the drone did not stall when the modified Hall magnetic sensor was placed in parallel with the power elements. This solution worked surprisingly well.

The modified Hall magnetic sensor was calibrated by running the microcontroller in ADC polling mode and recording the output values from the hall sensor to known current draws. The following table shows this calibration which allowed the precise determination of current draw at any moment.

| Load | Raw Analog In | Measured |
|---|---|---|
| Resistance | (Average of Two | Current |
| (Ohms) | Values Received) | (Milliamps) |
| 220 | 2297.5 | 24.3 |
| 200 | 2199.5 | 26.8 |
| 150 | 2200.5 | 35.7 |
| 100 | 2205.5 | 53.1 |
| 47 | 2222.5 | 111.5 |
| 22 | 2260.5 | 243.0 |
| 10 | 2342.5 | 508.0 |
| DC motor | 2555.0 | 1140.0 |
| No load | 2192.5 | 0.0 |

### Example 3

This example identifies requirements for a switching element in an exemplary battery management system, and techniques for verifying the requirements.

| Requirement | Verification |
|---|---|
| The switching module | A multimeter will be placed between the |
| should be able to | battery output and the drone's ESC input. |
| deliver up to 15 +− | The drone will then be throttled till the |
| A through the high- | meter reads 15 A and the indication LED |
| power cell. | for the high-power cell illuminates. The |
| | measured current draw from high power |
| | should be at least 15 A +− 1 A. |
| The switching module | A multimeter will be placed between the |
| should be able to | battery output and the drone's ESC input. |
| deliver up to 6 A | The drone will then be throttled till the |
| through the high- | meter reads 6 A and the indication LED for |
| capacity cell | the high-capacity cell illuminates. The |
| | measured current draw from high-capacity |
| | should be at least 6 A +− 2 A |
| The on-state | The switching module will be powered by a |
| resistance should | lab bench power supply. A multimeter will |
| be less than 20 | be used to measure the output voltage and |
| mOhms for both | current at the system's output. In a |
| switches | steady on state, the power at the output |
| | will be compared to the power output of |
| | the power supply. The difference should |
| | be less than 5 mW. |

### Example 4

This example describes how an algorithm is developed for the battery management system. (1) Data Collection: the developers collect as much data as possible on battery usage in our use case, in this case, an RC. (2) Data analysis: patterns in this data are analyzed to collect information such as how often power spikes occur, how long power spikes last, how long constant power draw lasts for, and charging tendencies. (3) Algorithm: using the analyzed data, the algorithm is developed that controls the hybrid battery system. The algorithm can be developed to manage the charge between the two energy elements such that the system is prepared to switch to the high power energy element when a power surge occurs and maintaining even charging and discharging curves for the high-capacity energy element to optimize its cycle-life The first step in developing the algorithm is to collect data on how the battery system is being used in the specific use case, which in this example is an RC. This data might include information on how often the RC is used, how long it is used for, and how much power it draws during different types of activities, such as acceleration or cruising.

Once the data has been collected, it is analyzed to identify patterns and trends that can inform the development of the algorithm. For example, the data might reveal that the RC experiences frequent power spikes during acceleration, and that these spikes tend to last for short periods of time. This information can be used to design a charging and discharging strategy that takes advantage of the high-power capabilities of one of the battery elements during these spikes. With this information in hand, the algorithm can be developed, which includes writing code that controls the charging and discharging of each battery element, based on the data analysis conducted earlier. For example, the algorithm might be designed to utilize the high-power battery element during periods of high demand, in order to maintain a more even charging and discharging cycle for the high-capacity element to optimize its cycle-life.

Overall, the goal of the algorithm is to ensure that the hybrid dual-chemistry battery system operates as efficiently and effectively as possible, providing the RC with the power it needs while also extending the lifespan of the batteries. By collecting and analyzing data on battery usage and designing an algorithm based on that data, developers can create a battery management system that is tailored to the specific needs of the RC, as well as any other devices or systems that might use a similar battery configuration.

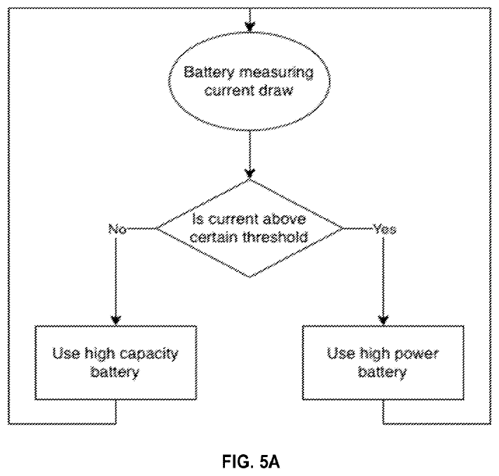

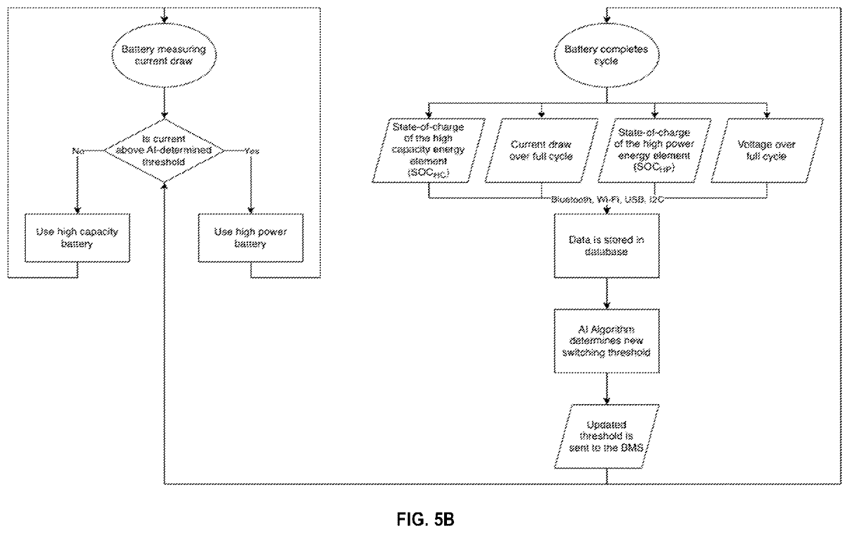

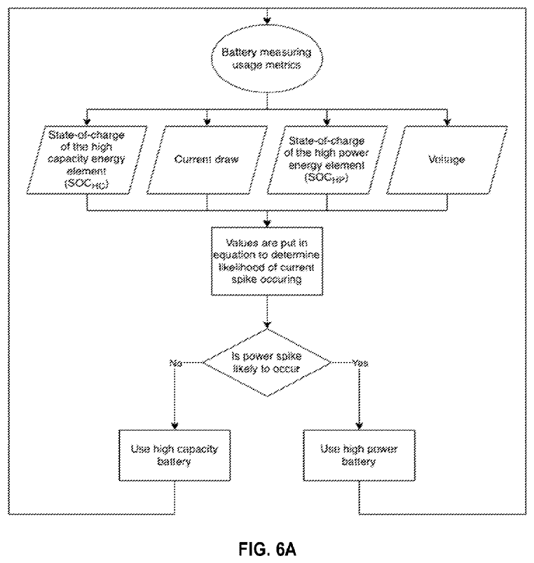

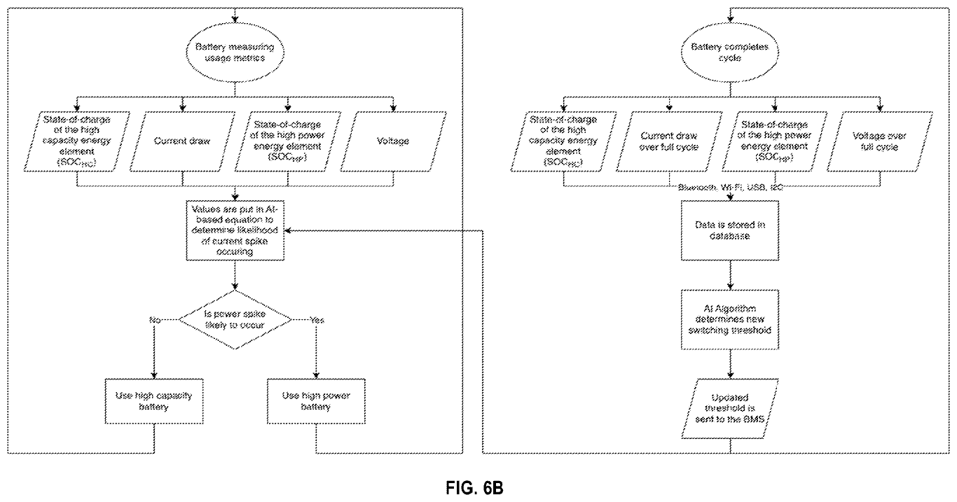

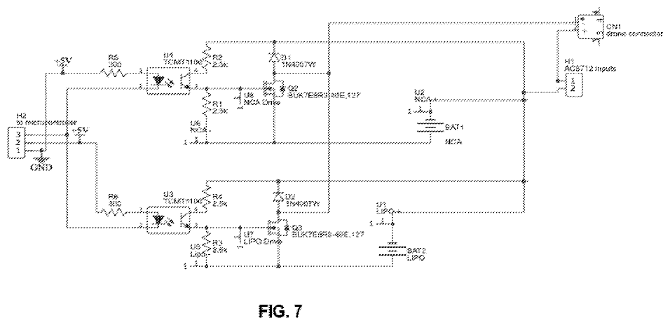

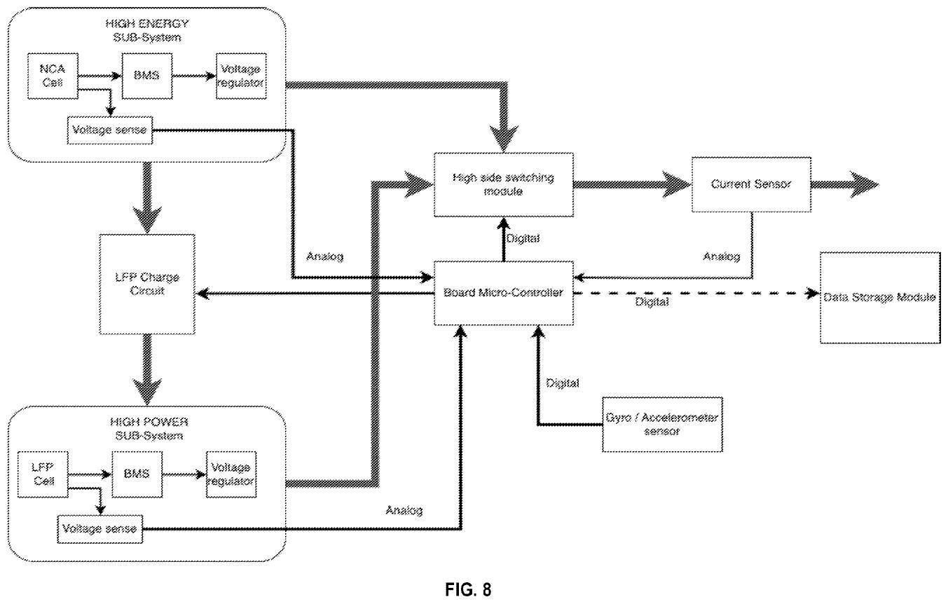

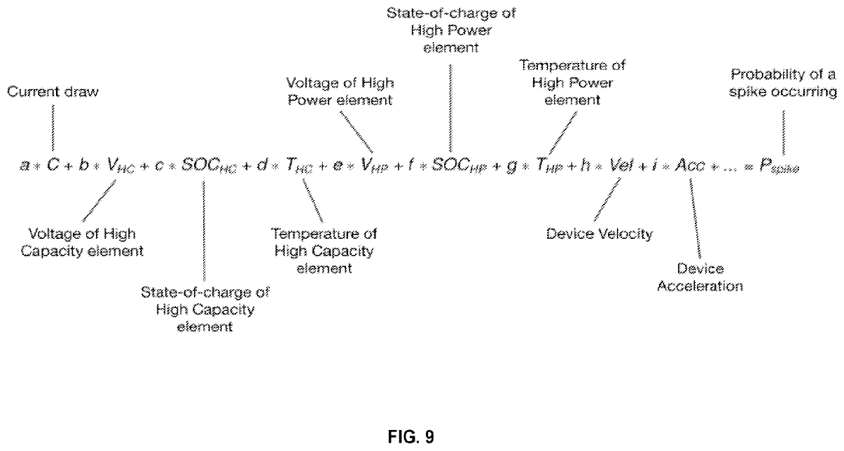

The algorithm that is executed on the battery management system can be executed in at least two ways: switching between the two energy elements at a certain current threshold or using an equation to estimate the likelihood of a power spike occurring and using that likelihood to decide which energy element to use, as depicted in FIG. 9. If the battery is switching at a certain threshold, the battery can use a predetermined threshold for its entire lifespan, as depicted in FIG. 5A. The threshold at which the battery switches can also change over the lifespan of the battery, as depicted in FIG. 5B. If the battery is using an equation to determine when to switch, the battery can use a predetermined equation for its entire lifespan, as depicted in FIG. 6A. The equation which is used to determine which element the battery uses can also change over the lifespan of the battery, as depicted in FIG. 6B.

The machine learning algorithm, which is operated on a backend server, can be based, for example, on linear regression, a neural network, or principal component analysis (PCA), although it is not meant to be limiting. Linear regression is a statistical method used to model the relationship between a dependent variable, in this case a power spike, and one or more independent variables, in this case the collected usage metrics. It assumes a linear relationship between the variables and aims to find the line of best fit that minimizes the difference between the predicted values and the actual values. A neural network is a type of machine learning model inspired by the structure and function of the human brain. It consists of layers of interconnected nodes or neurons, each processing and transforming the input data to produce an output. Neural networks are trained using a large amount of data to learn patterns and relationships and can be used for a variety of tasks such as classification, regression, and image recognition. PCA is a statistical technique used to reduce the dimensionality of a dataset while retaining as much of its original variability as possible. It achieves this by identifying the directions of maximum variance in the data and projecting the data onto those directions, known as principal components. PCA can be used to visualize high-dimensional data, compress data for easier storage and analysis, and improve the performance of machine learning algorithms.

### Example 5

This example describes tolerance analysis for a hybrid battery system. Due to the importance of capacity, the smart hybrid battery must greatly limit its power losses. As a result, the on-state resistance of the switches in the switching element is critically important as high currents will be flowing through them. Each side of the switching element will have the same switch so the resistive loss will be constant throughout a charge cycle.

A reasonable limit for total power loss can be set at 1 mWh. Given the data sheet of the switch, one can calculate what the power loss would be for the typical on-state resistance of 5.8 mOhms. Given that the intended capacity of the present system is 3.800 mAh, one can calculate the total power loss through the one single charge cycle, by assuming the system is outputting 3.8 amps for 1 hour. P=IR², so for the present system the typical power loss through one cycle is 3.8A*(0.00580 hm)²=0.000127 Wh or 0.127 mWh.

To perform the tolerance analysis, one can assume that the on-state resistance is in its worst-case scenario and the temperature is at 175 degrees Celsius. In this case on-state resistance is 14.1 mOhms, as given by the data sheet. Power loss would then be 3.8A*(0.01410 hm) 2=0.000755 Wh or 0.755 mWh. This is still less than 1 mWh, so the tolerance analysis passes.

### Example 6

This example shows how a control algorithm can be adjusted and used to extend the lifespan of a hybrid battery system. A hybrid battery system as described herein is used to power and operate a remote control (RC) airplane. During operation, data is collected for the state of charge of each energy element at all times, the timing for each energy element to supply power to the electrical load, and the time required for recharging the high-power energy element. The collected data is reported constantly via Bluetooth serial or Wi-Fi, and is used to create the “true” discharge curve of each energy element during each cycle. The true discharge cycle is used to train an algorithm to best emulate a reference or ideal discharge curve during future operation. After sufficient training, the control algorithm manages the energy elements so that the high-capacity energy element very closely follows a constant discharge over time. Limiting the maximum discharge and stabilizing the discharge curve of the high-capacity energy element can reduce cell degradation.

The smart hybrid battery system is designed for and installed on an RC plane. This medium was chosen because the battery size is large enough for the power usage of digital and analog electronics to not significantly matter, yet not too large as to exceed what would be practical for the purpose of this example. Also, an RC plane requires large current spikes quite often, and, during regular use, is not pushed to its capacity limit with each and every cycle. This creates an excellent perfect system to demonstrate how the present battery management system would in practice extend the usable lifespan of high-capacity rechargeable batteries, as it would detect these conditions and adjust the energy elements to best ensure long-term battery health by balancing what portion of the electrical load is delivered by each energy element in accordance with the number of additional cycles that each element is predicted to last.

For an unmanned aerial vehicle such as an RC airplane, the battery management system also includes a gyroscope and an accelerometer to provide data indicative of the speed and/or acceleration of the unmanned aerial vehicle as shown in FIG. 4.

### Example 7

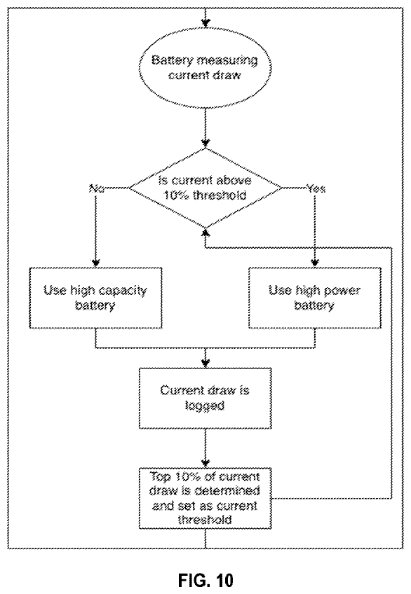

FIG. 10 shows a control algorithm for use cases where connectivity of the system to a cloud database is sparse or nonexistent. It involves calculating new current thresholds for the hybrid battery system based on recently collected data points. If the battery is switching at a certain current threshold, the battery can keep track of current values over the duration of the discharge cycle. It can then determine what current makes up the top portion of the total usage, in this example 10%. This current value can be set as the threshold at which the battery switches from the high-capacity element to the high-power element. By doing this, the battery can reserve the high-power element for the top 10% of the total power demand.

1. A hybrid battery system for an electrical load, comprising:
a high-power energy element;
a high-capacity energy element;
a connector for supplying electrical current from the hybrid battery system to an electrical load based on power demand of a device;
a switching element between the connector and the high-power energy element and/or the high-capacity energy element, wherein the switching element is configured to selectively establish, block, limit or increase electrical connection between the connector and one of or both the high-power energy element and the high-capacity energy element;
a sensor configured to measure current draw by the electrical load from the high-power energy element and/or the high-capacity energy element;
a controller configured to receive signals indicative of:
(i) a current draw measurement from the sensor,
(ii) a state-of-charge of the high-capacity energy element (SOC_{HC}); and
(iii) a state-of-charge of the high-power energy element (SOC_{HP}),
wherein the controller is further configured to operate the switching element to selectively connect the high-power energy element and/or the high-capacity energy element to the electrical load based on the detected SOC_{HP}, the detected SOC_{HC}, the current draw measurement.

2. The hybrid battery system of claim 1, wherein the high-capacity energy element has an energy density greater than 250 Wh/kg.

3. The hybrid battery system of claim 1, where the high-power energy element is capable of discharge at greater than 10 C.

4. The hybrid battery system of claim 1, wherein the high-power energy element comprises one or more LFP, LCO, LTO, LMO, a lithium polymer, sodium-ion, or lithium manganese cells.

5. The hybrid battery system of claim 4, wherein the high-capacity energy element comprises one or more NMC, NCA, lithium-sulfur, silicon-anode lithium ion, solid-state lithium ion, lithium metal, lithium nickel manganese cobalt oxide, lithium-air, or metal-air cells.

6-8. (canceled)

9. The hybrid battery system of claim 1, the sensor is capable of detecting current changes below 1 amp.

10. The hybrid battery system of claim 1, the switching element comprises a buffer circuit comprising power converters to maintain an output voltage that follows a desired discharge curve.

11. The hybrid battery system of claim 1, the switching element is configured to pulse charge the high-power energy element while supplying energy to an electrical load.

12. The hybrid battery system of claim 1, the switching element is configured to step charge the high-power energy element while supplying energy to an electrical load.

13. The hybrid battery system of claim 1, the switching element is configured to employ an algorithm to charge the high-power energy element while supplying energy to an electrical load.

14. The hybrid battery system of claim 1, the switching element has an on-state resistance of 10 milliOhms or less.

15. The hybrid battery system of claim 1, wherein the electrical load is a feature of a device and the controller is further configured to receive a signal indicative of (iv) speed and/or acceleration of the moving device.

16. The hybrid battery system of claim 1, wherein the controller is further configured to receive one or more signals indicative of time, individual cell temperature, internal resistance, GPS location, environmental conditions, temperature, and/or available sunlight.

17. A method of operating the hybrid battery system of claim 16, wherein the system switches to the high-power energy element when the load current draw is higher than a current draw threshold and/or the SOC_{HC} is lower than a SOC_{HC} threshold.

18-19. (canceled)

20. A method of operating the hybrid battery system of claim 1, wherein data from operation of the device is transmitted to a cloud database.

21-22. (canceled)

23. A method of determining a current draw threshold and/or a SOC_{HC} threshold comprising analyzing the usage patterns of specific electronic devices and their power requirements.

24-25. (canceled)

26. A method of operating a hybrid battery system comprising a high-power energy element and a high-capacity energy element, the method comprising the steps of:
a) monitoring a current draw by an electrical load from the hybrid battery system;
b) measuring a state-of-charge (SOC_{HP}) of the high-power energy element;
c) measuring a state-of-charge (SOC_{HC}) of the high-capacity energy element;
d) upon detecting a spike in the monitored current draw, comparing the measured SOC_{HP} with a SOC_{HP} limit, and comparing the measured SOC_{HC} with a SOC_{HC} limit, and based on the detected spike and the comparisons, adjusting supply of current to the electrical load from either the high-power energy element or the high-capacity energy element.

27. The method of claim 26, wherein the electrical load is a feature of a moving vehicle, and the method further comprises monitoring speed and/or acceleration of the moving vehicle.

28. The method of claim 26, further comprising charging the high-power energy element from the high-capacity energy element at a variably controllable rate to enable the high-capacity energy element to have a desired discharge curve through each discharge cycle.

29. The method of claim 26, wherein the high-power energy element is recharged from the high-capacity energy element during operation of the device.

30. (canceled)
